(19) United States
(12) Patent Application Publication
(10) Pub. No.: US 2026/0161210 A1
(43) Pub. Date: Jun. 11, 2026

(54) SHARED VOLTAGE RAIL FRAMEWORK FOR HETEROGENEOUS CPU CLUSTER

(71) Applicant: QUALCOMM Incorporated, San Diego, CA (US)

(72) Inventors: Hoan Huu NGUYEN, Cary, NC (US); Nitin MAKHIJA, San Jose, CA (US)

(21) Appl. No.: 18/976,008

(22) Filed: Dec. 10, 2024

(51) Int. Cl. G06F 1/28

(52) U.S. Cl. CPC G06F 1/28

(57) ABSTRACT

Certain aspects of the present disclosure provide various mechanisms that support opportunistically de-coupling groups of processing cores from a shared supply voltage rail in a heterogeneous CPU cluster. The mechanisms proposed herein may allow high performance cores memory supply voltage to be switched over to a different (non-shared) voltage supply rail. This switching may allow high performance core(s) to independently transition to higher performance states (P-states) without pulling up the shared voltage supply rail.

### FIELD OF THE DISCLOSURE

Aspects of the present disclosure relate to techniques for enhancing chip designs that utilize a voltage rail that is shared among groups of processing cores.

### BACKGROUND

A central processing unit (CPU) may include a processing unit (e.g., a core) that includes local memory, such as level 1 cache. The local memory may include a memory array that includes a plurality of memory cells. For instance, the memory cells may include static random access memory (SRAM) cells.

CPU clusters (CCs) may use different types of memory with different types of bitcells. For example, core memory (e.g., local memory accessed by a single core) may use a high current (HC) bitcell design to support high performance applications. A last level cache (LLC) shared by multiple cores, on the other hand, may use a high density (HD) bitcell design for area optimization (due to potentially large LLC size). LLC typically refers to a highest-numbered cache that is accessed by the cores prior to fetching from memory.

### SUMMARY

One aspect provides a method. The method includes selecting a first performance state (p-state) for a first group of processing cores, wherein the first group of processing cores shares a first voltage supply rail with at least a second group of processing cores; and decoupling memory of the first group of processing cores from the first voltage supply rail, when at least one condition involving the first p-state is met.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts a block diagram of a CPU cluster according to some aspects of the present disclosure.

FIG. 2 depicts an example application of an adaptive power multiplexer (APM) used to connect different power rails to a memory.

FIGS. 3A and 3B depict example dynamic voltage and frequency scaling (DVFS) tables for different core groups (CGs).

FIGS. 4A and 4B depict example DVFS tables for different CGs that share a common voltage supply rail.

FIGS. 5A and 5B depict example DVFS tables for different CGs that support decoupling of the shared common voltage supply rail, in accordance with aspects of the present disclosure.

FIG. 6 depicts an example of per-CG APMs that support decoupling of the shared common voltage supply rail, in accordance with aspects of the present disclosure.

FIG. 7 depicts an example of a shared rail manager (SRM) block, in accordance with aspects of the present disclosure.

FIGS. 8A and 8B depict an example p-state transition and corresponding shared common voltage supply rail changes, in accordance with aspects of the present disclosure.

FIG. 9 depicts an example mapping of p-states to electrical margin adjust (EMA) bands for different CGs, in accordance with aspects of the present disclosure.

FIGS. 10A, 10B, and 10C depict example register formats that may be used for p-state to EMA mapping, in accordance with aspects of the present disclosure.

FIG. 11 depicts example logic for generating memory dynamic performance setting bits, in accordance with aspects of the present disclosure.

FIG. 12 depicts an example method in accordance with aspects of the present disclosure.

FIG. 13 depicts an example device in accordance with aspects of the present disclosure.

### DETAILED DESCRIPTION

Aspects of the present disclosure relate to techniques for enhancing chip designs that utilize a voltage rail that is shared among groups of processing cores.

A heterogeneous CPU cluster with multiple core types may utilize multiple voltage supply rails to provide voltage input Vddmx, such as CPU_Mx (which is typically always on at a certain voltage level) and CPU_Cx (whose level may be dynamically changed to a higher voltage to support a higher clock frequency). In this manner, multiple independent Cx and Mx voltages pairs may enable independent Dynamic Voltage and Frequency Scaling (DVFS) for each core type. In this context, a voltage supply rail generally refers to a dedicated electrical pathway within a chip (e.g., an SoC) that delivers a specific voltage level to power different components. As the number of core types in a CPU cluster increases, the number of voltage rail pairs and their associated collateral circuits, such as a Power Management Integrated Circuit (PMIC) may also increase, which may increase cost and complexity.

To reduce cost, a voltage supply rail (e.g., CPU_Mx) may be shared across multiple core types to allow the number of voltage rails to be reduced. However, a shared voltage rail across multiple core types may reduce flexibility by imposing performance and power constraints to the entire CPU cluster as different core types (in a core group CG) may no longer have their own independent DVFS. In other words, a potential adverse impact of a shared voltage supply rail is that different core types may no longer be able to tune their voltage (e.g., and/or frequency) for different kinds of workload.

Aspects of the present disclosure, however, provide various mechanisms that support opportunistically de-coupling groups of processing cores from a shared Mx voltage rail in a heterogeneous CPU cluster. The mechanisms proposed herein may allow high performance cores memory (e.g., HC SRAM) Mx supply voltage to be switched over to the Cx rail. This switching (from an Mx rail shared among core groups-CGs-to a CG dedicated rail) may allow high performance core(s) to independently transition to higher performance states (P-states) without pulling up the shared Mx rail.

In some cases, to achieve the decoupling proposed herein, an adaptive power multiplexer (APM) may be used to connect different power rails to memory of a core group (CG). For example, in a high performance state (p-state), the APM may connect SRAM to a different voltage rail (CPU_Cx) whose level may be dynamically changed to a higher voltage (e.g., to support a higher clock frequency). On the other hand, in a lower p-state, the APM may connect the HC memory back to the shared CPU_Mx rail.

### Example CPU Cluster

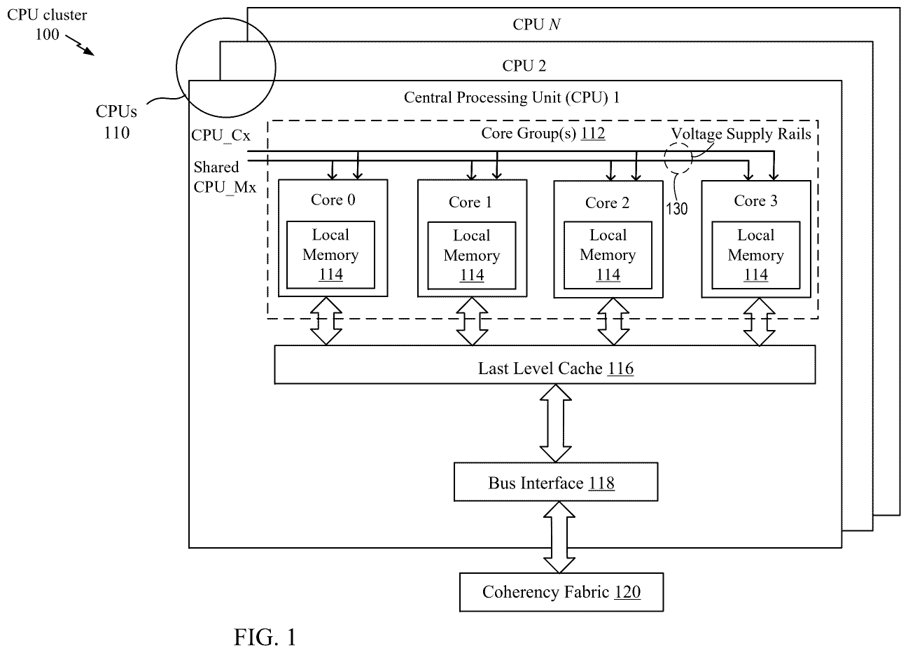

FIG. 1 depicts a block diagram of a CPU cluster 100 according to some aspects of the present disclosure. The CPU cluster 100 may include a plurality of CPUs 110. Each of the CPUs 110 may include a plurality of processing units 112. For example, as illustrated, each of the CPUs 110 may include four separate processing units 112 (e.g., labeled as Core 0, Core 1, Core 2, and Core 3). It should be appreciated that the scope of the present disclosure is not intended to be limited to CPUs have four separate processing units 112 and therefore may include CPUs having more or fewer processing units 112.

As illustrated, each of the processing units 112 may include a local memory 114 (e.g., level 1 cache). The local memory 114 is the most efficient (e.g., closest and fastest) memory source for the respective processing core 112. The local memory 114 may store data and instructions frequently accessed. By storing such data and instructions in the local memory 114, the respective processing unit 112 may access such data and instructions without having to access higher level memory (e.g., main memory).

Each of the CPUs 110 may include a last level cache 116 (e.g., referred to as level 3 cache). The last level cache 116 has a much larger storage capacity compared to the local memory 114 (e.g., level 1 cache) of each respective processing unit 112. As a result, the last level cache 116 may be shared amongst the plurality of processing units 112. Also, as the name suggests, the last level cache 116 represents the final cache before the respective CPU 110 accesses the main memory.

Each of the CPUS 110 may include a bus interface 118. The bus interface 118 may be a physical (and logical) interface that connects a respective CPU to other components. For example, the bus interface 118 may connect the respective CPU to a coherency fabric 120 (e.g., system bus) that connects the respective CPU to other CPUs included in the CPU cluster 100 as well as other components, such as main memory.

As illustrated at 130, the CPU cluster 100 may utilize multiple voltage supply rails to provide voltage input Vddmx, such as CPU_Mx and CPU_Cx. As illustrated, the CPU_Mx voltage supply rail may be shared across multiple core types to allow the number of voltage rails to be reduced.

### Aspects Related to a Shared Voltage Framework for a Heterogeneous CPU Cluster

As noted above, while a shared voltage supply rail may help reduce cost, it may also reduce flexibility as different core types may no longer have their own independent DVFS. In other words, a potential adverse impact of a shared voltage supply rail is that different core types may no longer be able to tune their voltage (or frequency) for different kinds of workload.

Aspects of the present disclosure, however, provide various mechanisms that support opportunistically de-coupling core groups (CGs) from a shared Mx voltage rail. In some cases, to achieve the decoupling proposed herein, an adaptive power multiplexer (APM) may be used to connect different power rails to memory of a core group (CG).

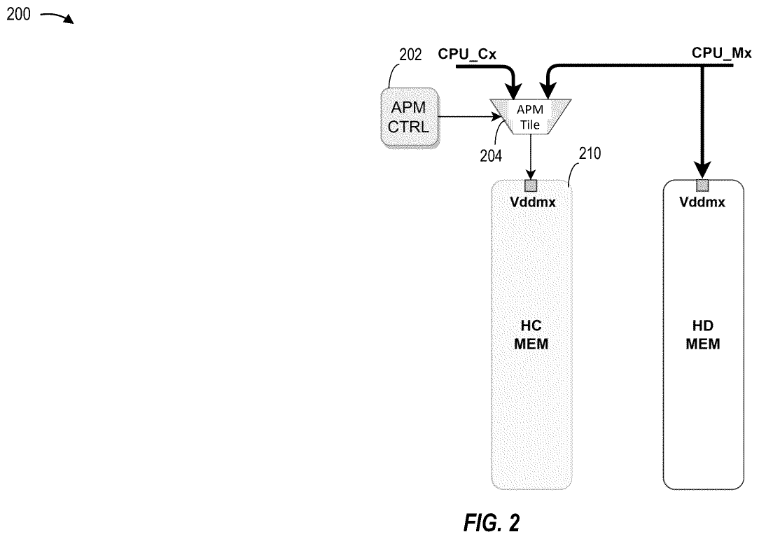

For example, as illustrated in diagram 200 of FIG. 2, in a high performance state (p-state), an APM controller 202 may control an APM multiplexer 204 to connect HC based SRAM 210 of a core to a different voltage rail (CPU_Cx) whose level may be dynamically changed to a higher voltage (to support a higher clock frequency). On the other hand, in a lower p-state, the APM may connect the HC memory back to the shared CPU_Mx rail.

As described above, DVFS may allow processor cores to switch between voltage and frequency levels based on real-time workload demands, automatically adjusting performance and power consumption. As an example, a processor or memory could have DVFS table entries with different voltage levels and corresponding frequencies. In some cases, each DVFS entry may correspond to a performance state (p-state). In general, higher p-states will have higher frequencies and correspondingly to higher voltages, while lower p-states will have lower frequencies and corresponding lower voltages to save power. The number of frequency steps in a DVFS table can vary depending on the processor architecture, with some offering finer-grained control than others. In some cases, an operating system may monitor system load and make decisions about when to switch between frequency levels (e.g., change p-states).

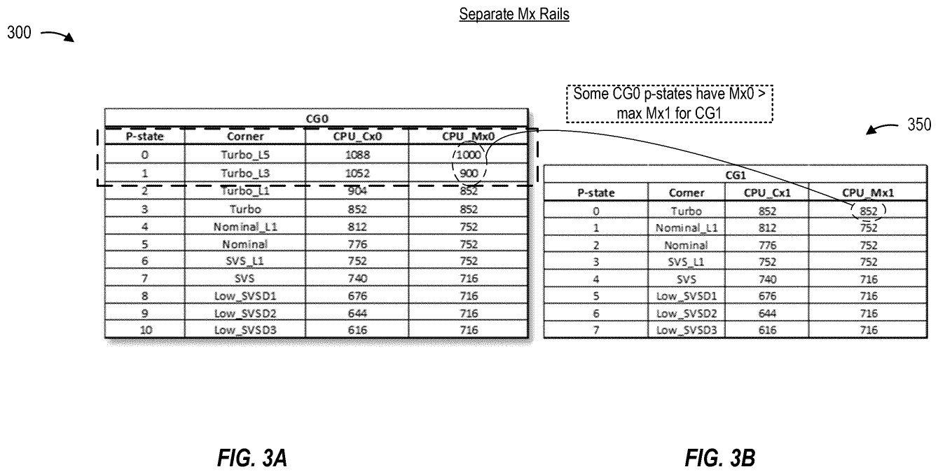

FIG. 3A illustrates an example DVFS table 300 with certain voltage levels for CPU_Cx, CPU_Mx for various p-states (the corresponding frequencies are not shown) for a first core group (CG0). FIG. 3B illustrates an example DVFS table 350 for a second core group (CG1).

As illustrated, tables 300 to table 350 allow each CG to have its own independent voltage/frequency operating conditions. In the illustrated example, CG0 supports high-performance cores with higher voltages and frequencies relative to CG1. As illustrated, certain p-states for CG0 (e.g., 100 mv and 900 mv for p-states 0 and 1) may have a higher voltage setting for Mx (CPU_Mx0) than a maximum Mx voltage for CG1 (e.g., 852 mv for p-state 0).

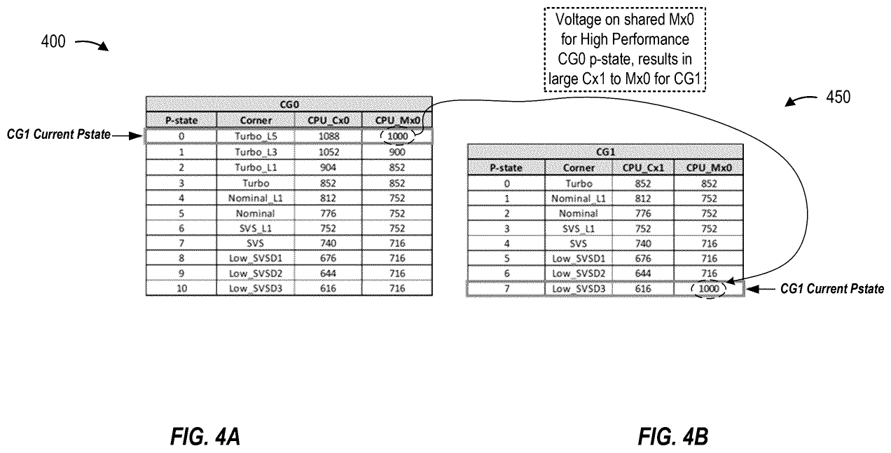

FIGS. 4A and 4B depict example DVFS tables 400 and 450, for CG0 and CG1, assuming a shared common voltage supply rail for Mx (thus denoted CPU_Mx0 in both tables).

As evidenced by comparing table 400 and 450, the high performance core group CG0 may utilize much high voltages and frequency to maximize performance. As a result, in certain scenarios, the shared CPU_Mx0 level may exceed what is needed for the lower performance core group CG1. For example, when CG0 is in p-state 0 and CG1 is in p-state 7, the high CPU_Mx0 level used by CG0 results in a large CPU_Cx1 to CPU_Mx0 voltage skew at CG1.

The large CPU_Cx1 to CPU_Mx0 skew may create issues, such as adversely impacting SRAM robustness. Further, SRAM Cx-to-Mx skew limits may from technology node to technology node. As a result, a large Cx-to-Mx voltage difference constraint in SRAM could limit system performance.

According to certain aspects, to provide the architectural flexibility to decouple the different CGs from CPU_Mx dependency, each CG may have APM circuitry that allows switching its supply voltage (VDDAR) to CPU_Cx.

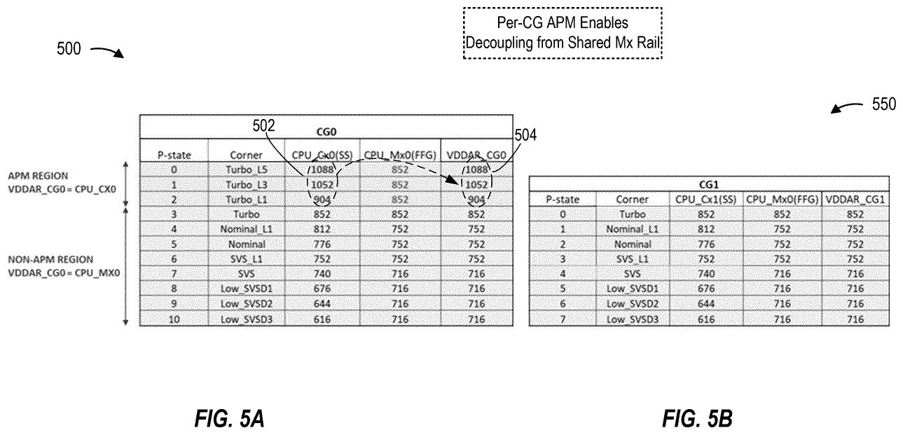

FIGS. 5A and 5B depict example DVFS tables 500 and 550 for different CGs that supports such switching. As illustrated in table 500 for CG0, this switching to CPU_Cx may occur when a high performance CG transitions to a Pstate with CPU_Mx voltage exceeding the lower performance CGs maximum voltage. In the illustrated example, CG0 switches its memory supply rail (VDDAR_CG0) to CPU_Cx0 when CG0 transitions to P-state 2 or higher, allowing higher voltage for VDDAR_CG0 (as shown at 502 and 504). As illustrated in table 550, this decoupling allows CG1 to retain control over CPU_Mx0 and remain in lower performance P-states (avoiding the large Cx-to-Mx voltage difference shown in table 450 of FIG. 4B).

As indicated in FIG. 4A, the group of p-states (e.g., p-states 0-2) for which the APM switches VDDAR_CG0 to Cx (VDDAR_CG0=CPU_CX0) may be referred to as an APM region. The group of lower p-states (e.g., p-states 3-10) for which the APM switches VDDAR_CG0 to the common Mx rail (VDDAR_CG0=CPU_MX0) may be referred to as a non-APM region.

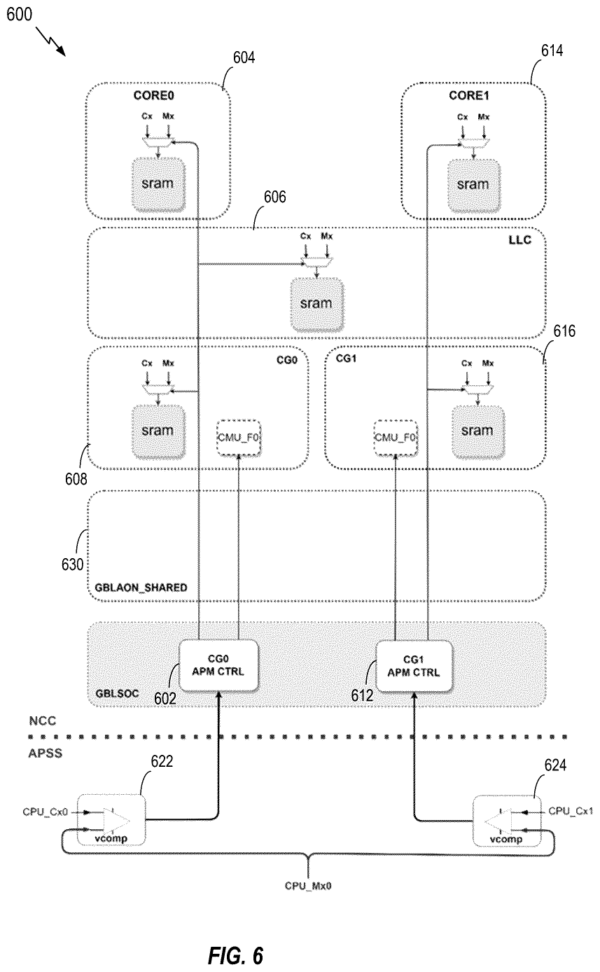

Diagram 600 of FIG. 6 illustrates example per-CG APM components that may help enable each CG to decouple from a shared CPU_Mx rail. As illustrated, CG0 APM control 602 may allow decoupling memory of CG0 components (604, 606, and 608) from the shared CPU_Mx rail (e.g., when a voltage comparator 622 detects CPU_Cx0 exceeds the CPU_Mx0 voltage). Similarly, CG1 APM control 612 may allow decoupling memory of CG1 components (614, 616, and 618) from the shared CPU_Mx rail (e.g., when a voltage comparator 624 detects CPU_Cx1 exceeds the CPU_Mx0 voltage).

Such per-CG APM functionality may allow a high performance CG to operate at a higher supply voltages and frequencies in the APM region, as depicted in table 500 of FIG. 5A, by switching its VDDAR_CG rail to CPU_Cx.

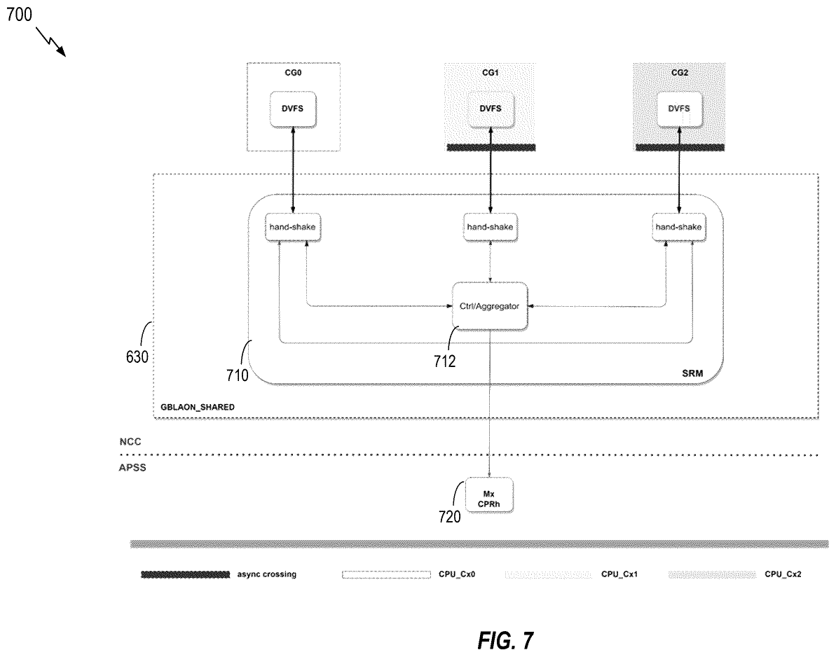

According to certain aspects, p-state transitions of different cores may be coordinated by a component 630. As illustrated in diagram 700 of FIG. 7, this component 630 may include shared rail manager (SRM) logic 710 that includes an aggregator 712. This aggregator may effectively act as a central command point, where each CG sends a request when transitioning to a new P-state. The SRM may aggregate such requests and ultimately send a final Mx voltage change request (e.g., to a CPU power resource CPR component 720). In addition, the SRM may communicates a final arbitrated Mx voltage value to each CG. Each CG may, in turn, ensure that its memories (and other components) are properly set to remain functional with the new Mx voltage. As will be described in greater detail below, this may be accomplishes via memory dynamic performance bit settings that adjust internal operation (e.g., sense amplifier) of memories according to voltage and frequency settings.

As noted above, in the APM region, the highest performance CG (CG0) in the cluster may operate in P-states where voltage/frequency points are much higher than the more power conscious core types. As the high performance CG transitions to into (or out) its target Pstate in the APM region, the shared Mx rail may go through multiple voltage changes (stop-over points) corresponding to the different voltage levels listed for Mx0 in the DVS tables (e.g., 716, 752, and 852). During this transition to different Mx0 voltage levels, the SRM may help ensures that all the CGs use correct memory dynamic performance bit settings for their memories to remain operation during this transition.

As noted above, the (per-CG) APM system may autonomously switch the high performance CG (CG0) VDDAR to CPU_Cx (or shared CPU_Mx depending on Pstate low to high or high to low transition) when conditions are met.

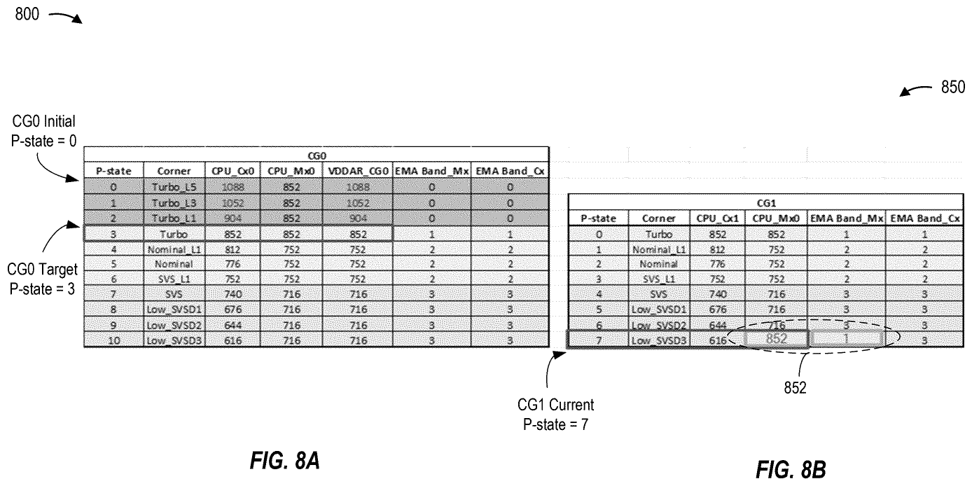

An example sequence of changing the shared CPU_Mx0 voltage levels and corresponding APM control for a p-state transition may be understood with simultaneous reference to FIG. 7 and the tables 800 and 850 shown in FIG. 8A and FIG. 8B. The example sequence a p-state transition from the APM region into the non-APM region (but a similar sequence would be performed transitioning into the APM region).

FIGS. 8A and 8B also illustrate how subsets of p-states may be grouped into electrical margin adjust (EMA) bands. EMA bands may allow designers greater flexibility in voltage and frequency settings, allowing certain circuits to remain operational at lower voltage ranges. EMA bands may allow incremental changes in overlapping (extended) voltage ranges, when switching between widely disparate p-states (e.g., from p-state 15 to p-state 0). EMA bands may be entered via the memory dynamic performance setting bits described above.

As illustrated in table 800 of FIG. 8A, the example assumes CG0 is initially in p-state 0, with VDDAR_CG 0 decoupled from the shared CPU_Mx 0 rail) and the current CG1 p-state is 7. As illustrated in table 650 of FIG. 6A, for p-state 7 of CG1, CPU_Mx0 may be at an initial setting of 716 mv).

As illustrated, CG0 has a target p-state of 3 (e.g., due to accommodate a change in workload). The following sequence may be performed to transition CG0 from the initial p-state 0 to the target p-state 3.

As a first step, CG0 may send a Pstate change request to the SRM 710. SRM may receive this request and note it (e.g., as CG0, Pstate=3). As a second step, the SRM may request CG1 to set the memory dynamic performance setting bits to achieve an EMA of 2, in anticipation of a change of the shared Mx rail (e.g., to 752 mv). To accomplish this voltage change, at a third step, the SRM may send a voltage change request (e.g., to CPR 720 to change to 752 mv) for CG1. As shown in table 850, the Mx rail would typically only change (from 716 to 752 mv) with Pstate=3. In some cases, the SRM may receive an acknowledgment of the CG1 voltage change from CPR.

In anticipation of a change of the shared Mx rail to the voltage level corresponding to the target CG1 p-state 3 (e.g., to 852 mv), the SRM may requests CG1 to the SRM may request CG1 to set the memory dynamic performance setting bits to achieve an EMA of 1. Again, the SRM may send a voltage change request to CPR for CG1. As shown in table 850, the Mx rail would typically only change (from 752 to 852 mv) with Pstate=0. Again, the SRM may receive a voltage change acknowledgment from CPR.

The SRM may then send voltage change request to CPR for CG0. As illustrated in table 800 the Cx voltage for CG0 may change to be the same as Mx for Pstate=3. Thus, the APM multiplexer for CG0 may switch (to again couple to the shared Mx rail) during this window. Again, the SRM may receive the voltage change acknowledgment from CPR.

At this point, the p-state transition for CG0 (from p-state 0 to p-state 3) may be considered complete. As illustrated at 852 in FIG. 8B, while CG1 remains in its current p-state 7, the Mx voltage level has changed to 852 mv with an EMA Band=1 (a change from Mx=716 mv shown for CG1 p-state 7 in table 650).

For p-state transitions within the non-APM region, a similar sequence of steps may be performed, but without APM switching.

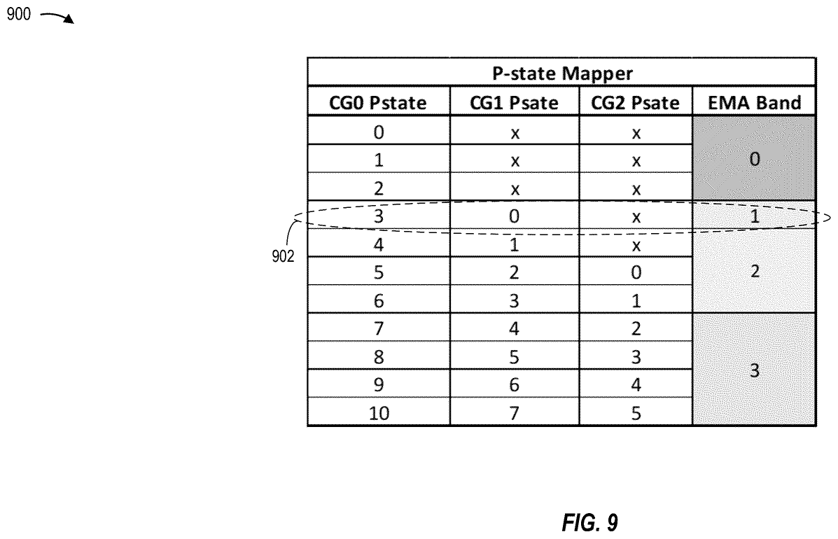

In some cases, to help support such p-state transitions, a shared-Mx DVFS arbiter may maintains multiple P-state mappings (mapping p-states for different CGs to different EMA bands), as illustrated in table 900 of FIG. 9. These mappings may effectively serve as lookup tables during Pstate aggregation. A separate P-state mapping may be used for each CG.

Each P-state in the mapping may correspond to an equivalent P-state in the other CG (e.g., with a corresponding CPU_Mx voltage level). For example, as illustrated at 902, CG0 p-state 0 may map to corresponding CG1 p-state 0 (that both have an Mx voltage of 852 mv and corresponding to EMA band 1). Based on this, the SRM may know what EMA to request prior to requesting an Mx voltage change.

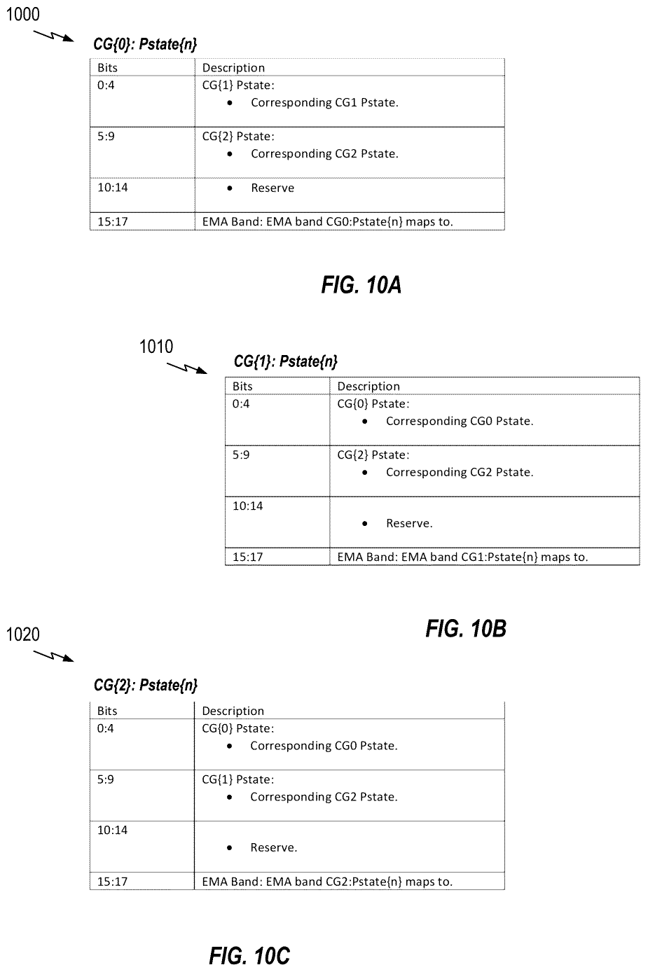

FIGS. 10A, 10B, and 10C depict example register formats 1000, 1010, and 1020 that may be used for setting the p-state to EMA mapping for a 3 CG example (CG0, CG1, and CG2). For example, register 1000 may include bit fields that show how a given CG0 Pstate (n) maps to corresponding P-states for CG1 and CG2, and the corresponding EMA band that CG0 Pstate(n) maps to. Similarly, register 1010 may include bit fields that show how a given CG1 Pstate (n) maps to corresponding P-states for CG0 and CG2, and the corresponding EMA band that CG1 Pstate(n) maps to. Finally, register 1020 may include bit fields that show how a given CG2 Pstate (n) maps to corresponding P-states for CG0 and CG1, and the corresponding EMA band that CG2 Pstate(n) maps to.

In general, the values of different memory dynamic performance setting bits may depend on Cx/Mx voltage levels. As described in the above example, with a shared Mx rail, the Mx based memory dynamic performance setting bits may need to be driven to SRAM instances when a Mx voltage change occur. This is a change from design implementations that drive both Mx and Cx ACC bits when there is a Pstate transition (as Cx and Mx values change as a pair. Because a shared Mx rail may result in Mx voltage changes only (without Cx voltage changes) in some scenarios, only Mx memory dynamic performance setting bits may need to be set.

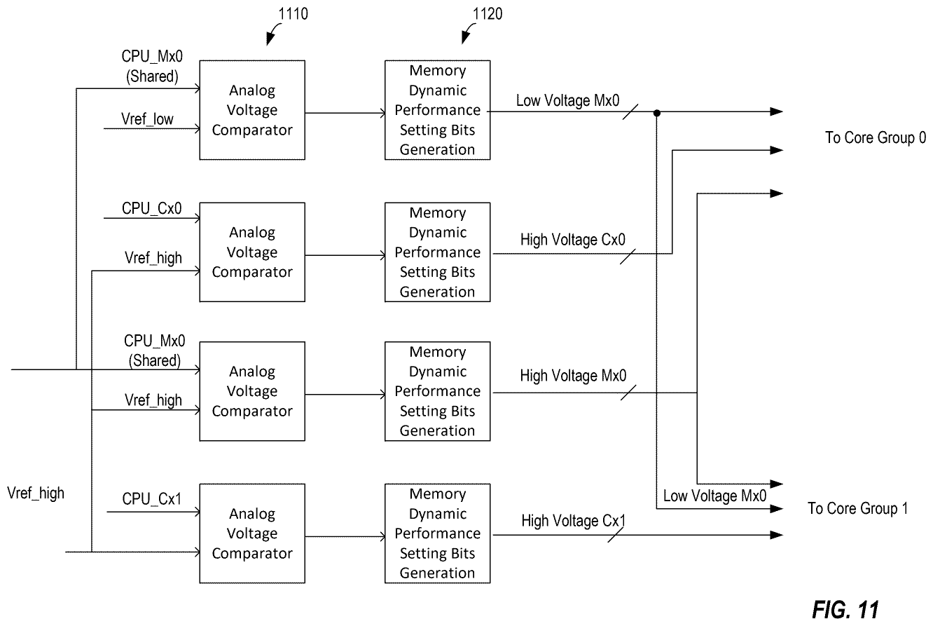

Aspects of the present disclosure provide logic that may allow Cx and Mx memory dynamic performance setting bits to be set independently. For example, FIG. 11 depicts example logic for independently generating such Cx and Mx memory dynamic performance setting bits.

As illustrated, the outputs of a set of voltage comparators 1110 may determine the bit values generated by memory dynamic performance setting bit generation logic 1120. The example shows logic for a 2 CG example, but it should be readily apparent that additional circuitry could support a larger number of CGs.

For example, a first voltage comparator may compare the shared CPU_Mx0 to a low reference voltage (e.g., 776 mv). If CPU_Mx 0 is less than the low reference voltage, the corresponding memory dynamic performance setting bits may be generated to values corresponding to a low voltage Mx0.

A second voltage comparator may compare the CG0 Cx voltage (CPU_Cx0) to a high reference voltage (e.g., 850 mv). If CPU_Cx 0 is greater than the high reference voltage, the corresponding memory dynamic performance setting bits may be generated to values corresponding to a high voltage Cx0.

A third voltage comparator may compare shared CPU_Mx0 to the high reference voltage. If CPU_Mx0 is greater than the high reference voltage, the corresponding memory dynamic performance setting bits may be generated to values corresponding to a high voltage Mx0.

A fourth voltage comparator may compare the CG1 Cx voltage (CPU_Cx1) to the high reference voltage. If CPU_Cx1 is greater than the high reference voltage, the corresponding memory dynamic performance setting bits may be generated to values corresponding to a high voltage Cx1.

As illustrated, the various memory dynamic performance setting bits may be provided to the corresponding CGs (and used to set their corresponding memories/other components). For example, the low voltage Mx0, high voltage Mx0, and high voltage Cx0 bits may be provided to CG0. Similarly, the low voltage Mx0, high voltage Mx0, and high voltage Cx1 bits may be provided to CG1.

### Example Operations

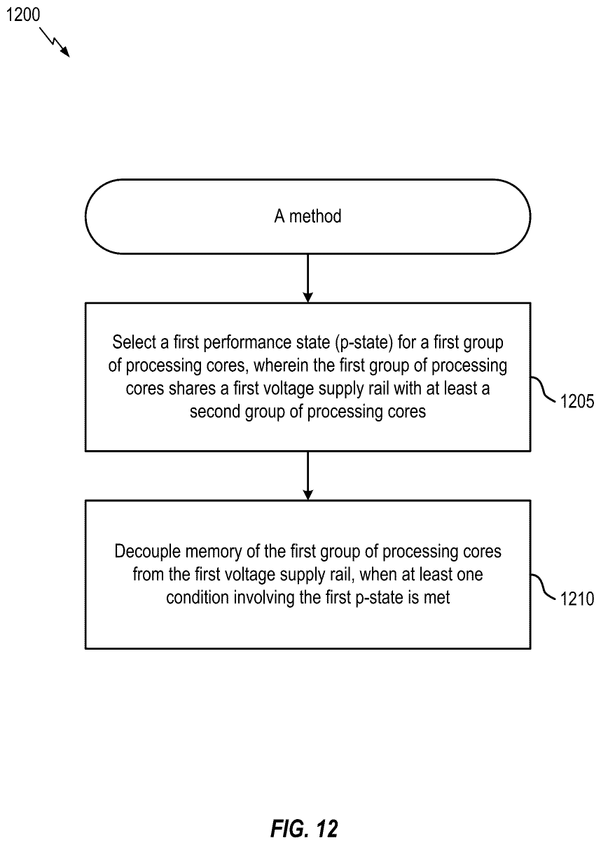

FIG. 12 shows an example of a method 1200 of wireless communication at a wireless node. In some examples, the wireless node is a user equipment. In some examples, the wireless node is a network entity, such as a BS or a disaggregated base station.

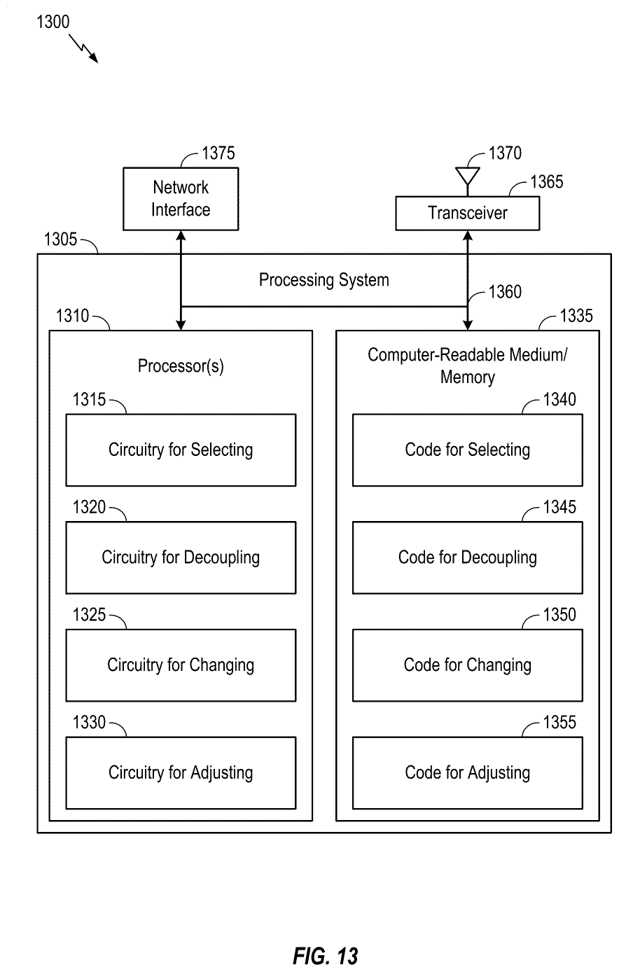

Method 1200 begins at step 1205 with selecting a first performance state (p-state) for a first group of processing cores, wherein the first group of processing cores shares a first voltage supply rail with at least a second group of processing cores. In some cases, the operations of this step refer to, or may be performed by, circuitry for selecting and/or code for selecting as described with reference to FIG. 13.

Method 1200 then proceeds to step 1210 with decoupling memory of the first group of processing cores from the first voltage supply rail, when at least one condition involving the first p-state is met. In some cases, the operations of this step refer to, or may be performed by, circuitry for decoupling and/or code for decoupling as described with reference to FIG. 13.

In some aspects, the decoupling involves a first multiplexor that also couples the memory of the first group of processing cores to a second voltage supply rail when the at least one condition is met.

In some aspects, the first multiplexor comprises an adaptive power multiplexor (APM) responsive to a control signal generated by first APM control logic associated with the first group of processing cores.

In some aspects, the first group of processing cores includes an APM for each processing core in the first group; and the APM for each processing core in the first group is responsive to the control signal generated by the first APM control logic.

In some aspects, the second group of processing cores includes an APM for each processing core in the second group; and the APM for each processing core in the second group is responsive to a control signal generated by second APM control logic.

In some aspects, the at least one condition involves an operating voltage associated with the first p-state.

In some aspects, the at least one condition is considered met when the operating voltage associated with the first p-state exceeds a reference voltage.

In some aspects, the reference voltage corresponds to a maximum operating voltage associated with the second group of processing cores.

In some aspects, the first p-state is in a region of p-states with associated operating voltages that exceed a maximum operating voltage associated with the second group of processing cores.

In some aspects, the memory of the first group of processing cores is decoupled from the first voltage supply rail when the first group of processing cores transitions from a p-state outside of the region to a p-state inside the region.

In some aspects, the method 1200 further includes changing a voltage level of the first voltage supply rail as at least one of the first group of processing cores or the second group of processing cores transitions between different p-states. In some cases, the operations of this step refer to, or may be performed by, circuitry for changing and/or code for changing as described with reference to FIG. 13.

In some aspects, different subsets of p-states of the first group of processing cores and second group of processing cores are associated with different electrical margin adjust (EMA) bands.

In some aspects, the method 1200 further includes adjusting operation of memory of at least one of the first group of processing cores or the second group of processing cores based on the EMA bands. In some cases, the operations of this step refer to, or may be performed by, circuitry for adjusting and/or code for adjusting as described with reference to FIG. 13.

In some aspects, the adjusting is achieved via memory dynamic performance setting bits.

In some aspects, values of the memory dynamic performance setting bits are determined based on at least one output of voltage comparators that compare voltages of the first and second supply voltage rails to reference voltages.

In some aspects, the memory of the first group of processing cores comprises high current (HC) bitcells; and memory of the second group of processing cores comprises high density (HD) bitcells.

In one aspect, method 1200, or any aspect related to it, may be performed by an apparatus, such as communications device 1300 of FIG. 13, which includes various components operable, configured, or adapted to perform the method 1200. Communications device 1300 is described below in further detail.

Note that FIG. 12 is just one example of a method, and other methods including fewer, additional, or alternative steps are possible consistent with this disclosure.

### Example Communications Device(s)

FIG. 13 depicts aspects of an example communications device 1300. In some aspects, communications device 1300 is a user equipment. In some aspects, communications device 1300 is a network entity, such as a BS or a disaggregated base station.

The communications device 1300 includes a processing system 1305 coupled to the transceiver 1365 (e.g., a transmitter and/or a receiver). In some aspects (e.g., when communications device 1300 is a network entity), processing system 1305 may be coupled to a network interface 1375 that is configured to obtain and send signals for the communications device 1300 via communication link(s), such as a backhaul link, midhaul link, and/or fronthaul link. The transceiver 1365 is configured to transmit and receive signals for the communications device 1300 via the antenna 1370, such as the various signals as described herein. The processing system 1305 may be configured to perform processing functions for the communications device 1300, including processing signals received and/or to be transmitted by the communications device 1300.

The processing system 1305 includes one or more processors 1310. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, cause the one or more processors 1310 to perform the method 1200 described with respect to FIG. 12, or any aspect related to it. Note that reference to a processor performing a function of communications device 1300 may include one or more processors 1310 performing that function of communications device 1300.

In the depicted example, computer-readable medium/memory 1335 stores code (e.g., executable instructions), such as code for selecting 1340, code for decoupling 1345, code for changing 1350, and code for adjusting 1355. Processing of the code for selecting 1340, code for decoupling 1345, code for changing 1350, and code for adjusting 1355 may cause the communications device 1300 to perform the method 1200 described with respect to FIG. 12, or any aspect related to it.

The one or more processors 1310 include circuitry configured to implement (e.g., execute) the code stored in the computer-readable medium/memory 1335, including circuitry for selecting 1315, circuitry for decoupling 1320, circuitry for changing 1325, and circuitry for adjusting 1330. Processing with circuitry for selecting 1315, circuitry for decoupling 1320, circuitry for changing 1325, and circuitry for adjusting 1330 may cause the communications device 1300 to perform the method 1200 described with respect to FIG. 12, or any aspect related to it.

Various components of the communications device 1300 may provide means for performing the method 1200 described with respect to FIG. 12, or any aspect related to it. For example, means for transmitting, sending or outputting for transmission may include transceivers and/or antenna(s) such as the transceiver 1365 and the antenna 1370 of the communications device 1300 in FIG. 13. Means for receiving or obtaining may include the transceiver 1365 and the antenna 1370 of the communications device 1300 in FIG. 13.

### Example Clauses

Implementation examples are described in the following numbered clauses:
Clause 1: A method, comprising: selecting a first performance state (p-state) for a first group of processing cores, wherein the first group of processing cores shares a first voltage supply rail with at least a second group of processing cores; and decoupling memory of the first group of processing cores from the first voltage supply rail, when at least one condition involving the first p-state is met.
Clause 2: The method of Clause 1, wherein the decoupling involves a first multiplexor that also couples the memory of the first group of processing cores to a second voltage supply rail when the at least one condition is met.
Clause 3: The method of Clause 2, wherein the first multiplexor comprises an adaptive power multiplexor (APM) responsive to a control signal generated by first APM control logic associated with the first group of processing cores.
Clause 4: The method of Clause 3, wherein: the first group of processing cores includes an APM for each processing core in the first group; and the APM for each processing core in the first group is responsive to the control signal generated by the first APM control logic.
Clause 5: The method of Clause 3, wherein: the second group of processing cores includes an APM for each processing core in the second group; and the APM for each processing core in the second group is responsive to a control signal generated by second APM control logic.
Clause 6: The method of any one of Clauses 1-5, wherein the at least one condition involves an operating voltage associated with the first p-state.
Clause 7: The method of Clause 6, wherein the at least one condition is considered met when the operating voltage associated with the first p-state exceeds a reference voltage.
Clause 8: The method of Clause 7, wherein the reference voltage corresponds to a maximum operating voltage associated with the second group of processing cores.
Clause 9: The method of any one of Clauses 1-8, wherein the first p-state is in a region of p-states with associated operating voltages that exceed a maximum operating voltage associated with the second group of processing cores.
Clause 10: The method of Clause 9, wherein the memory of the first group of processing cores is decoupled from the first voltage supply rail when the first group of processing cores transitions from a p-state outside of the region to a p-state inside the region.
Clause 11: The method of Clause 10, further comprising changing a voltage level of the first voltage supply rail as at least one of the first group of processing cores or the second group of processing cores transitions between different p-states.
Clause 12: The method of Clause 11, wherein different subsets of p-states of the first group of processing cores and second group of processing cores are associated with different electrical margin adjust (EMA) bands.
Clause 13: The method of Clause 12, further comprising adjusting operation of memory of at least one of the first group of processing cores or the second group of processing cores based on the EMA bands.
Clause 14: The method of Clause 13, wherein the adjusting is achieved via memory dynamic performance setting bits.
Clause 15: The method of Clause 14, wherein values of the memory dynamic performance setting bits are determined based on at least one output of voltage comparators that compare voltages of the first and second supply voltage rails to reference voltages.
Clause 16: The method of Clause 9, wherein: the memory of the first group of processing cores comprises high current (HC) bitcells; and memory of the second group of processing cores comprises high density (HD) bitcells.
Clause 17: An apparatus, comprising: at least one memory comprising executable instructions; and at least one processor configured to execute the executable instructions and cause the apparatus to perform a method in accordance with any combination of Clauses 1-16.
Clause 18: An apparatus, comprising means for performing a method in accordance with any combination of Clauses 1-16.
Clause 19: A non-transitory computer-readable medium comprising executable instructions that, when executed by at least one processor of an apparatus, cause the apparatus to perform a method in accordance with any combination of Clauses 1-16.
Clause 20: A computer program product embodied on a computer-readable storage medium comprising code for performing a method in accordance with any combination of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Means for selecting, means for decoupling, and means for changing may comprise one or more processors, such as one or more of the processors described above with reference to FIG. 13.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus, comprising:
at least one memory comprising computer-executable instructions; and
one or more processors configured to execute the computer-executable instructions and cause the apparatus to:
select a first performance state (p-state) for a first group of processing cores, wherein the first group of processing cores shares a first voltage supply rail with at least a second group of processing cores; and
decouple memory of the first group of processing cores from the first voltage supply rail, when at least one condition involving the first p-state is met.

2. The apparatus of claim 1, wherein the decoupling involves a first multiplexor that also couples the memory of the first group of processing cores to a second voltage supply rail when the at least one condition is met.

3. The apparatus of claim 2, wherein the first multiplexor comprises an adaptive power multiplexor (APM) responsive to a control signal generated by first APM control logic associated with the first group of processing cores.

4. The apparatus of claim 3, wherein:
the first group of processing cores includes an APM for each processing core in the first group; and
the APM for each processing core in the first group is responsive to the control signal generated by the first APM control logic.

5. The apparatus of claim 3, wherein:
the second group of processing cores includes an APM for each processing core in the second group; and
the APM for each processing core in the second group is responsive to a control signal generated by second APM control logic.

6. The apparatus of claim 1, wherein the at least one condition involves an operating voltage associated with the first p-state.

7. The apparatus of claim 6, wherein the at least one condition is considered met when the operating voltage associated with the first p-state exceeds a reference voltage.

8. The apparatus of claim 7, wherein the reference voltage corresponds to a maximum operating voltage associated with the second group of processing cores.

9. The apparatus of claim 1, wherein the first p-state is in a region of p-states with associated operating voltages that exceed a maximum operating voltage associated with the second group of processing cores.

10. The apparatus of claim 9, wherein the memory of the first group of processing cores is decoupled from the first voltage supply rail when the first group of processing cores transitions from a p-state outside of the region to a p-state inside the region.

11. The apparatus of claim 10, wherein the one or more processors are further configured to cause the apparatus to:
change a voltage level of the first voltage supply rail as at least one of the first group of processing cores or the second group of processing cores transitions between different p-states.

12. The apparatus of claim 11, wherein different subsets of p-states of the first group of processing cores and second group of processing cores are associated with different electrical margin adjust (EMA) bands.

13. The apparatus of claim 12, wherein the one or more processors are further configured to cause the apparatus to:
adjust operation of memory of at least one of the first group of processing cores or the second group of processing cores based on the EMA bands.

14. The apparatus of claim 13, wherein the adjusting is achieved via memory dynamic performance setting bits.

15. The apparatus of claim 14, wherein values of the memory dynamic performance setting bits are determined based on at least one output of voltage comparators that compare voltages of the first and second supply voltage rails to reference voltages.

16. The apparatus of claim 9, wherein:
the memory of the first group of processing cores comprises high current (HC) bitcells; and
memory of the second group of processing cores comprises high density (HD) bitcells.

17. A method, comprising:
selecting a first performance state (p-state) for a first group of processing cores, wherein the first group of processing cores shares a first voltage supply rail with at least a second group of processing cores; and
decoupling memory of the first group of processing cores from the first voltage supply rail, when at least one condition involving the first p-state is met.

18. The method of claim 17, wherein the decoupling involves a first multiplexor that also couples the memory of the first group of processing cores to a second voltage supply rail when the at least one condition is met.

19. The method of claim 18, wherein the first multiplexor comprises an adaptive power multiplexor (APM) responsive to a control signal generated by first APM control logic associated with the first group of processing cores.

20. An apparatus, comprising:
means for selecting a first performance state (p-state) for a first group of processing cores, wherein the first group of processing cores shares a first voltage supply rail with at least a second group of processing cores; and
means for decoupling memory of the first group of processing cores from the first voltage supply rail, when at least one condition involving the first p-state is met.
